(19) United States
(12) Patent Application Publication
(10) Pub. No.: US 2007/0240359 A1
(43) Pub. Date: Oct. 18, 2007

(54) Reversible dual action fishing lure

(76) Inventor: Donald Edward Jalbert, South Hampton, NH (US)

Correspondence Address: Donald Edward Jalbert, 15 Main Ave., South Hampton, NH, 03827, US

(21) Appl. No.: 11/731,991

(22) Filed: Apr. 2, 2007

Related U.S. Application Data
(60) Provisional application No. 60/788,199, filed on Apr. 3, 2006.

(51) Int. Cl. A01K 85/00

(52) U.S. Cl. 43/42.22; 43/42.09; 43/42.36

(57) ABSTRACT

A reversible fishing lure wherein the lure body is designed in two halves with each half producing a distinct and unique action. Each action depends upon which half of the lure body is the lead half when it is pulled through the water. The lead half is determined by a removable, repositionable line attachment device or pin. The pin has the hook permanently attached to one end and the line attachment hole at the other. The pin and can be removed and re-inserted through either end of the lure body through a channel that runs the length of the lure body. This allows the fisherman to change the action of the lure by simply changing the orientation of the pin within the lure body. The reversible lure allows multiple surface and sub-surface action combinations and allows a fisherman more versatility while carrying fewer lures. One lure, two actions, more fish.

This patent claims the benefit of provisional patent application Ser. No. 60/788,199 filed Apr. 3, 2006 by the present inventor. The name of the invention has been changed.

### FEDERALLY SPONSORED RESEARCH

Not Applicable

### SEQUENCE LISTING OR PROGRAM

Not Applicable

### BACKGROUND

1. Field of Invention

This invention relates to recreation fishing with artificial lures and the method of line attachment to various types of artificial fishing lures.

2. Prior Art

Recreational fishing in the 21^{st} century will reach new heights in the development of artificial fishing lures. Fishing lures are being developed using the highest technology in the universal attempt to inspire a fish to strike. Many lures designs focus upon specific fish species and other can be used across the wide range of fish residing in both saltwater and freshwater.

One such fish is the striped bass, one of the most sought after fish on either coast of the United States. Striped Bass are highly developed omnivores that will eat anything available in their given location. This fact enables fishermen to use a wide variety of lures in their efforts to catch this elusive fish. This also makes it difficult for the fisherman since the exact diet of the striped bass is never the same at any given time, the old adage of “match the hatch” does not always apply.

Fishermen using a lure that mimics a squid when the striped bass are feeding on mackerel will have a more difficult time catching fish.

Another factor involved with striped bass is that they feed voraciously and visibly at times allowing a fisherman to target the lure to a specific spot. However, if the action of the lure is not agreeable to the stripers the fisherman's efforts will be in vain. The fisherman will either fail to catch a fish or the feeding or “blitzing” fish will move away before the fisherman can deploy another lure with a different, potentially more attractive action.

The reversible fishing lure was developed to enable fisherman to successfully change the action of a lure allowing the fisherman to quickly adapt to any given situation presented at the fishing location.

Typically, full bodied artificial fishing lures use wire that is permanently positioned inside the body of the lure. This method allows the lure to be pulled through the water in one direction and only allow one action provided by the design of the lure body.

The reversible lure utilizes a metal removable pin instead of the usual wire to secure the line and hook to the lure. The hook is permanently attached to the removable pin. The pin fits into a channel bored through the center of the lure along the longitudinal axis.

The lure body is designed so that each half of the lure is shaped to give a different action. The position of the pin determines which action will be presented. To change the action the fisherman detaches the line from the pin removes the pin from the body of the lure and re-inserts the pin through the lure body from the opposite end. The fisherman re-attaches the line and casts. The lure will now produce a different action when retrieved. Another benefit of the removable pin is that the type of hook can be quickly changed. The fisherman simply detaches the line, pulls out the pin, and re-inserts a different pin with a different hook attached. The same principle applies to the lure bodies. A fisherman can have one pin but can easily switch lure bodies. Both situations allow a fisherman to change actions and hooks very quickly allowing maximum potential for success at any given fishing situation.

The removable pin is designed to fit lure bodies that have been designed to accommodate it. The pin can be of any type of metal but brass and stainless steel are the types predominantly used. The removable pin can be flat, round, or hollow metal stock and can be of any shape as long as it can pass through the body of the lure and be easily removed and repositioned. The hooks utilized can be any of the various types manufactured by major tackle companies.

The lure bodies can be made of wood, plastic, or any other composite material. Each body is designed for two actions in the following configurations or combinations: Note: All the following actions are tried and true lure actions. The removable and repositionable pin allows them to be combined and utilized in the reversible application the pin allows.

1). Popper/Darter

2). Popper/Swimmer

3). Popper/Diver

4). Swimmer/Diver

5). Darter/Diver

6). Darter/Swimmer

The sizes of the lures are variable.

Definitions:

Popper: A surface lure that bounces along the surface when retrieved. The front end is cut at a 35 degree angle and hollowed out forming a cup at the hook attachment area. The cupped opening creates a splash of water and a slight popping sound when retrieved. This action resembles an injured prey species.

Darter: A surface lure that darts from side to side when retrieved. The front end of a darter also referred to as a spook, is pointed at the hook attachment position. This side to side action resembles a prey species feeding on the surface.

Swimmer: A sub surface lure that is designed with either an angle cut into the body itself or has an attached dive plane that pulls the lure under water when retrieved. This swimming action resembles prey species swimming below the surface of the water.

Diver: This sub surface lure has the same action as the swimmer but the dive planes are arranged differently so the lure will dive deeper to perform the swimming action.

### SUMMARY

The availability of a dual action lure enables fishermen to carry less gear, maintain a wide variety of fishing actions and greater opportunities to catch their target species.

### DRAWINGS—FIGURES

In the drawings closely related drawings have the same number but different alphabetical suffixes.

FIG. 1A to 1C show the removable repositionable pin. The ends are ground to accommodate the fishing hardware and are perpendicular for proper orientation of the hook.

FIG. 2A shows an example of the popper-darter style lure body and shows the relative position of the channel into which the metal pin can be positioned. FIG. 2B show the same lure from the head on position. FIG. 2C shows one half of the lure body designed to create the popper action. FIG. 2D show the opposite end designed for darter type action.

FIG. 3A shows the popper darter lure body with the pin inserted to produce the popper action of the lure. FIG. 3B shows the fully rigged pin outside of the body of the lure.

FIG. 3C shows the lure body has been repositioned on the pin to produce the darter action of the lure. In both instances the fishing line is attached at (10).

FIG. 4A to 4E show the mechanics involved with larger versions of the lure and the placement of additional hooks within the body of the lure and how the hooks will be secured within the body of a larger version of the lure.

### DRAWINGS—REFERENCE NUMERALS

10 line attachment hole
11 hook attachment hole
12 metal pin made of brass or stainless steel
13 split ring used to attach hook to hole
14 popper/darter lure body one half is a popper the other a darter
15 hook
19 device used to secure additional hooks to lure
20 channel through lure for pin
21 three way rig prior to adaptation to become number 19
22 cavity for additional hook attachment device

### DETAILED DESCRIPTIONS

The entire concept of a reversible lure depends upon the ability to change the position of the hook and line at the attachment points. Lure manufacturers have created reversed lures basically selling one version of a popular lure with the line and hook attachment positions opposite the original version. These reversed positions create a different action but the hook and line attachment positions remain permanently attached and cannot be changed.

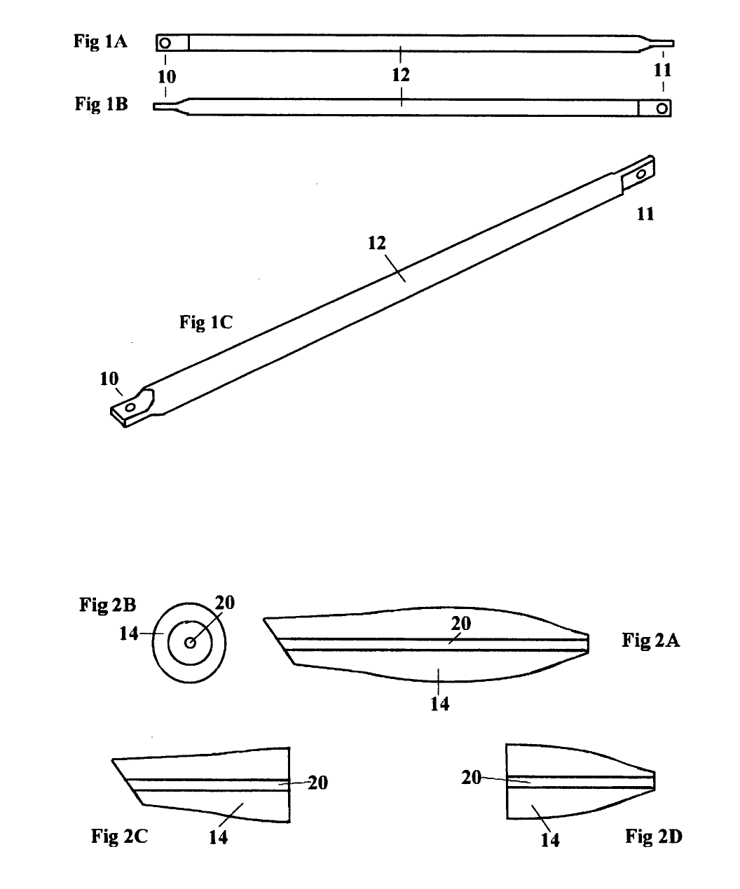

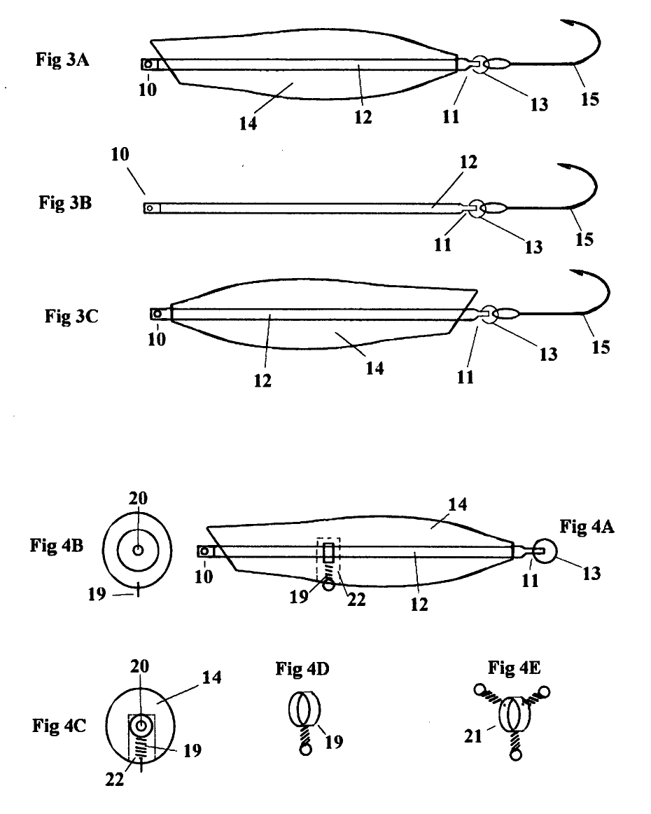

The metal pin (12) depicted in FIG. 1 is the hook and line attachment device and can be removed intact. The hook or line can be attached at either end of a given pin (12) and the attachment is permanent. The pin (12) size and length is relative to the size of the lure body (14) with 3.18 mm, 3.57 mm, and 3.97 mm thicknesses utilized by the inventor for production at this time. Each end is reduced in size to 1.59 mm in order to accommodate the hardware necessary for the attachment hardware. The line attachment position (10) has a 1.98 mm hole for the attachment of the line either directly as popular with many fishermen or with a snap swivel which is equally popular. The opposite end (11) is also drilled out to 1.98 mm. This end is the hook attachment position (11) and readily accepts the split ring hardware (13) needed to attach the hook (15) to the pin. The fully rigged pin (12) is depicted in FIG. 3B.

FIG. 2A shows one version of the body of the lure (14). A 3.55 mm channel (20) is bored through the center of the lure body longitudinally and will accommodate a 3.18 mm pin (12). The pin is centered within the body of the lure as depicted in the head on profile FIG. 2B (20). Each end of the lure can be designed for a specific action and a typical design is illustrated in FIG. 2C and FIG. 2D. Each half is shown by itself. FIG. 2C shows the popper half of the lure body. One half of the lure body (14) is cut at a 35 degree angle and the front end is hollowed out to create the popping sound upon retrieval. The opposite end of the lure body (14) is pointed and creates a darting action when retrieved by this end. The removable pin (12) allows each end to be used during the fishing experience. The lure bodies can be designed in multiple combinations and configurations to produce different actions in each half of the lure. The key is the removable pin (12) which allows each half to be utilized.

FIG. 3A shows the fully rigged pin (FIG. 3B) (12) inserted into the lure body (14). In this orientation the lure body (14) will be pulled through the water from the popper end (FIG. 2C) of the lure body (14) creating a bouncing popping action. The action can be changed by removing and repositioning the pin (12) within the lure body (14).

The pin (FIG. 3B) (12) is removed and repositioned within the lure body (14). FIG. 3C shows the pin (12) within the lure body in the orientation for darting action (FIG. 2D). The lure body (14) which is now reversed will create a darting action when retrieved through the water. By simply removing and repositioning the pin (12) within the channel (20) within the lure body (14) the lure body (14) will be reversed upon pin and each end of the lure can be used to produce two distinct or dual actions.

Larger lure bodies require additional hooks. These hooks are traditional attached to the ventral or bottom side of the lure body. The method of attaching different hooks is shown in FIGS. 4A, 4B, 4C, 4D, 4E. FIG. 4 A shows the lure body (14) with a cavity (22) created to accept the insertion of the additional hook attachment hardware (19). This hardware is fashioned from an piece of existing fishing tackle known as a three way swivel FIG. 4E (21). Two pieces of this fishing tackle are removed. The remaining section (19) is depicted in FIG. 4D. This hardware is inserted and glued into the cavity (22) within the lure body (14) and positioned so the center channel (20) can pass through the ring. The additional hook is attached to the device (19) and is permanently attached to the lure body (14). FIG. 4C is a cutaway view from the head position showing the additional hook device (19) within the lure body (14). The pin (12) passes through the channel (20) and through the device (19). This allows for larger applications of the removable and repositionable pin (12) to utilize the reversible dual action of the lure body.

Some of the advantages of reversible lures are that fishermen can carry less lures while maintaining a wide variety of actions. They will be able to easily switch lure bodies of different styles or colors as needed. With additional pins with different hooks attached they can quickly change hook types, single, double, or treble, or change to hooks dressed with different attraction features such as hair, feathers, or plastics as desired or needed.

The reversible dual action fishing lure will allow fishermen to carry a larger variety of lure actions while carrying fewer lures allowing them to travel lighter and allow fishermen more diverse methods of attracting fish.

1. A reversible dual action fishing lure that utilizes a removable repositionable metal pin thereby allowing said reversible dual action fishing lure to perform two different actions based upon the orientation of said removable repositionable pin within the body of said reversible dual action fishing lure.

2. said reversible dual action fishing lure of claim 1 has a longitudinal channel therein the body of said reversible dual action fishing lure whereby to accommodate said removable repositionable pin.

3. said removable repositionable pin of claim 1 is solid metal or metal tubing in any shape.

4. whereby said removable repositionable pin of claim 1 means for attachment of the fishing line therein on one end and the fishing hook on the other.

5. wherein aid removable repositionable pin of claim 1 secures additional hook hanging devices built into the body of said reversible fishing lure.

6. Said reversible dual action fishing lure body has two distinct actions designed into each end of said reversible dual action fishing lure
